(19) United States
(12) Patent Application Publication
(10) Pub. No.: US 2025/0083523 A1
(43) Pub. Date: Mar. 13, 2025

(54) PARKING ASSISTANCE APPARATUS AND PARKING ASSISTANCE METHOD

(71) Applicant: Panasonic Automotive Systems Co., Ltd., Kanagawa (JP)

(72) Inventors: Takafumi TOKUHIRO, Kanagawa (JP); Masashi HOSHINO, Tokyo (JP); Yukihiro TANIZOE, Osaka (JP); Tomoya ISHII, Hiroshima (JP)

(73) Assignee: Panasonic Automotive Systems Co., Ltd., Kanagawa (JP)

(21) Appl. No.: 18/958,934

(22) Filed: Nov. 25, 2024

Related U.S. Application Data
(63) Continuation of application No. PCT/JP2023/019835, filed on May 29, 2023.

(30) Foreign Application Priority Data
May 30, 2022 (JP) 2022-087744

(51) Int. Cl. B60K 35/28; B60K 35/22; B60K 35/26

(52) U.S. Cl. CPC B60K 35/28; B60K 35/22; B60K 35/26; B60K 2360/16

(57) ABSTRACT

A parking assistance apparatus performing parking assistance based on a route of a vehicle in teaching travel, the parking assistance apparatus including: a processor that determines whether an operation amount of a driver in the teaching travel of the vehicle exceeds a predetermined range, in which the processor executes predetermined processing in a case where the operation amount exceeds the predetermined range.

### TECHNICAL FIELD

The present disclosure relates to a parking assistance apparatus and a parking assistance method.

### BACKGROUND ART

A parking assistance apparatus capable of parking in a specific parking space based on teaching travel has been known. Such a parking assistance apparatus stores, through the driver's operation, a travel route of a vehicle as a teaching route when the vehicle is parked in a parking space and then automatically parks the vehicle in the parking space based on this teaching route (for example, see Japanese Unexamined Patent Application Publication (Translation of PCT Application) No. 2013-530867).

### CITATION LIST

### Patent Literature

PTL 1

Japanese Unexamined Patent Application Publication (Translation of PCT Application) No. 2013-530867

### SUMMARY OF INVENTION

### Technical Problem

### Solution to Problem

A parking assistance apparatus according to the present disclosure is a parking assistance apparatus performing parking assistance based on a route of a vehicle in teaching travel, the parking assistance apparatus including: a processor that determines whether an operation amount of a driver in the teaching travel of the vehicle exceeds a predetermined range, in which the processor executes predetermined processing in a case where the operation amount exceeds the predetermined range.

A parking assistance method according to the present disclosure is a parking assistance method for performing parking assistance based on a route of a vehicle in teaching travel, the parking assistance method including: determining whether an operation amount of a driver in the teaching travel of the vehicle exceeds a predetermined range; and executing predetermined processing in a case where the operation amount exceeds the predetermined range.

### Advantageous Effects of Invention

According to the present disclosure, it is possible to suppress the occurrence of an error in route following during automatic parking.

### BRIEF DESCRIPTION OF DRAWINGS

FIG. 1 is a block diagram illustrating a configuration example of a vehicle to which a parking assistance apparatus according to an embodiment of the present disclosure is applied;

FIG. 2 illustrates an exemplary route of teaching travel;

FIG. 3 illustrates an exemplary route reproduced by automatic parking based on the route of the teaching travel;

FIG. 4 illustrates a displaying example on a display in a state before execution of predetermined processing;

FIG. 5 illustrates a displaying example on the display after execution of the predetermined processing;

FIG. 6 is a flowchart illustrating an operation example of control during the teaching travel in the parking assistance apparatus;

FIG. 7 is a block diagram illustrating a configuration example of a vehicle to which a parking assistance apparatus according to a variation is applied;

FIG. 8 is a block diagram illustrating another configuration example of the vehicle to which the parking assistance apparatus according to the variation is applied; and

FIG. 9 is a block diagram illustrating yet another configuration example of the vehicle to which the parking assistance apparatus according to the variation is applied.

### DESCRIPTION OF EMBODIMENTS

### Embodiment

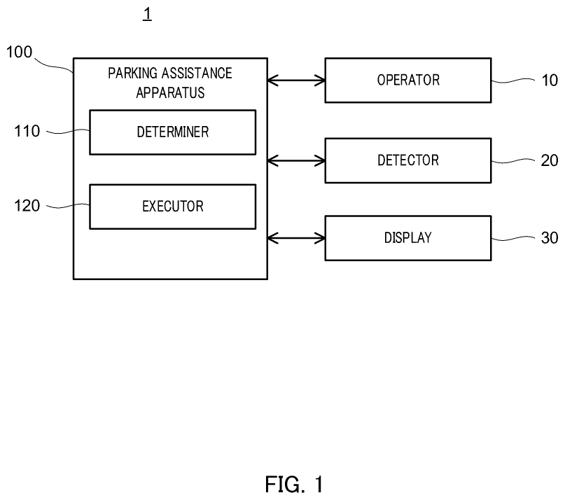

Hereinafter, an embodiment of the present disclosure will be described in detail with reference to the drawings. FIG. 1 is a block diagram illustrating a configuration example of vehicle 1 to which parking assistance apparatus 100 according to an embodiment of the present disclosure is applied.

As illustrated in FIG. 1, vehicle 1 includes: an automatic parking assistance (so-called home-zone parking assistance) function that causes vehicle 1 to be automatically parked in a predetermined parking space; operator 10; detector 20; display 30; and parking assistance apparatus 100.

Operator 10 includes a steering wheel, an accelerator pedal, and the like used by a driver to perform a driving operation for vehicle 1. The driving operation for vehicle 1 refers to, for example, operations related to driving vehicle 1 such as a steering operation of vehicle 1 and a traveling operation of vehicle 1.

Detector 20 detects an operation amount of operator 10. Detector 20 may be a publicly known sensor capable of detecting, for example, a steering angle, an accelerator pedal position, and the like.

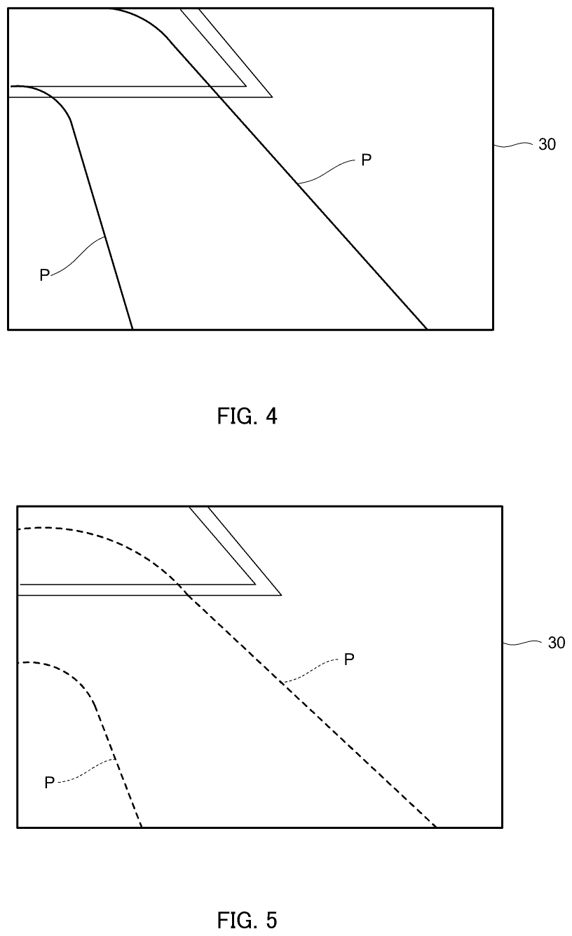

Display 30 is, for example, a display of a car navigation apparatus or the like. Display 30 displays, for example, a predicted course line for vehicle 1 when the driver performs a teaching travel for automatic parking (see solid lines P and the like in FIG. 4). Note that the display may be any one other than a car navigation apparatus, such as a head-up display (including an augmented reality head-up display).

Parking assistance apparatus 100 includes a central processing unit (CPU), a read only memory (ROM), a random access memory (RAM), and an input/output circuit, and executes automatic parking control to automatically park the vehicle in a predetermined parking space. Specifically, parking assistance apparatus 100 stores, through the driver's operation, a route when the vehicle is parked in the predetermined parking space and an operation of operator 10 by the driver, as teaching travel data. Then, when vehicle 1 is parked in the predetermined parking space next time, vehicle 1 executes control to park automatically (automatic parking control) based on the teaching travel data.

In the present embodiment, parking assistance apparatus 100 executes, in addition to the automatic parking control, predetermined processing for causing the driver to recognize that the operation amount by the driver in the teaching travel is outside an operation range in which automatic parking is executable. Parking assistance apparatus 100 includes determiner 110 and executor 120.

Determiner 110 determines whether the operation amount by the driver during the teaching travel of vehicle 1 exceeds a predetermined range. The operation amount by the driver is, for example, a steering angle. The predetermined range is an operation range in which the automatic parking is executable.

The operation range in which the automatic parking is executable is, for example, an operation range in which the route of the teaching travel can be followed when the route is reproduced by the automatic parking based on the operation of operator 10 performed by the driver during the teaching travel.

For example, there is a case where the driver enters the parking space in a state where the steering angle of the steering wheel (operator 10) is close to the maximum angle in the teaching travel. When the route and the operation of operator 10 in the teaching travel is reproduced by the automatic parking, it is likely that a route of the automatic parking (automatic parking route) may expand with respect to the route of the teaching travel (teaching travel route) due to a failure to follow the teaching travel route.

A specific description will be given below. Generally, a start position for automatic parking is a position deviated from a start position for the teaching travel. For this reason, in order to reproduce a teaching travel route, the automatic parking is performed to follow (reproduce) the teaching travel route by controlling a vehicle such that the deviation can be cancelled.

However, when a steering angle in the teaching travel is at the maximum angle, the steering cannot be turned any further in a region where the steering angle is at the maximum angle even when an attempt is made to align the deviated position with the teaching travel route, and thus, an automatic parking route becomes a route that expands with respect to the teaching travel route without being aligned to the teaching travel route.

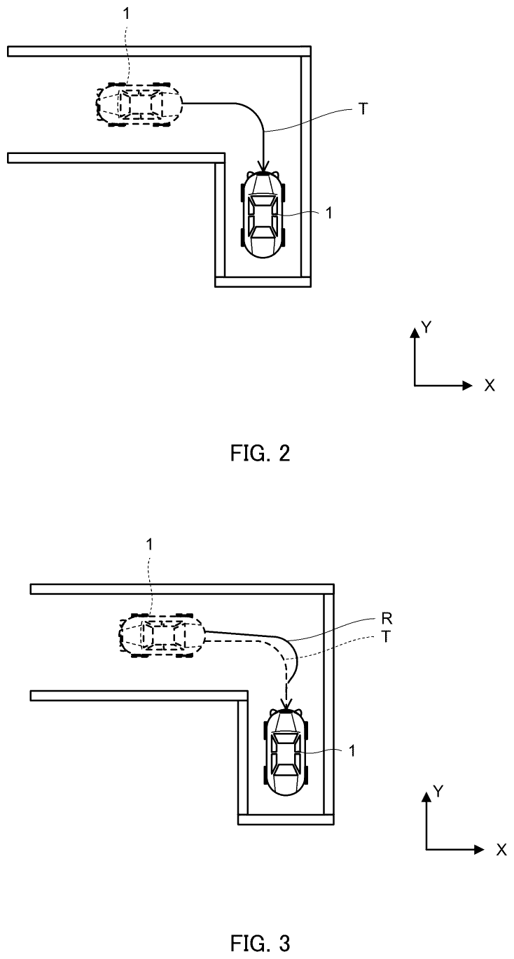

For example, as illustrated in FIG. 2, it is assumed that there is a parking space into which a vehicle can enter by turning from a road extending in an X direction toward a negative (−) side of a Y direction.

Note that, in the descriptions of FIG. 2 and the like, an orthogonal coordinate system (X, Y) is used. The common orthogonal coordinate system (X, Y) is used also in the drawings described later. For example, the X direction indicates the left-right direction, and the Y direction indicates the front-rear direction.

Suppose, when the driver performs the teaching travel with the steering angle of operator 10 being at the maximum angle, the vehicle passes through a route along a shape of the road, that is, the route that proceeds to a positive (+) side of the X direction, turns the corner relatively smoothly, and then proceeds to the − side of the Y direction to enter the parking space (see arrow T).

However, as illustrated in FIG. 3, due to the steering angle of operator 10 being at the maximum angle in the teaching travel and the start position in the automatic parking being deviated from the start position in the teaching travel, there may be a case, in the automatic parking, where the vehicle enters the parking space through a route (see arrow R) to trace a trajectory that expands to the + side of the X direction at the corner, for example. This is because the route in the teaching travel is a route achieved with the maximum steering angle, and thus, it is not possible to further increase the steering angle in a case where the start position is deviated, and the deviation cannot be corrected.

As described above, the automatic parking route may greatly deviate from the teaching travel route due to the occurrence of deviation of the start position, delay in the steering control, and other errors, in the route following during the automatic parking. For this reason, for example, in a case where an accurate route following is required, such as in a narrow parking space or the like, vehicle 1 is likely to collide with surrounding walls, which may cause the automatic parking to fail.

In contrast, in the present embodiment, when the steering angle is equal to or greater than a predetermined angle, for example, determiner 110 determines that the operation amount by the driver is outside the operation range in which the automatic parking is executable. The predetermined angle may be appropriately set, for example, as 90% of the maximum angle of the steering angle or the like.

Executor 120 executes predetermined processing for notifying the driver that the operation amount by the driver is outside a predetermined range, in accordance with the determination result of determiner 110. That is, executor 120 executes the predetermined processing in a case where the operation amount by the driver exceeds the predetermined range. The predetermined processing is, for example, processing that changes a predetermined display content in display 30 of vehicle 1 from the displaying before execution of the predetermined processing.

For example, when parking is performed in the teaching travel, predicted course lines P in vehicle 1 are displayed on display 30 as a predetermined display content, as illustrated in FIG. 4. Predicted course lines P form, for example, a predicted route on which vehicle 1 travels, based on the current steering angle in vehicle 1. Note that predicted course line P may be indicated by a line representing an outer edge of the region within which vehicle 1 moves. As another example, the shape of predicted course line P is not limited to a straight line and may also be indicated by a curved line. Further, as another example of a predetermined display content, a region surrounded by predicted course lines P may be overlaid with a predetermined color and may be displayed as a predicted course region. In a case where the outer edge of the predicted course region is indicated by a line, the predicted course region may be displayed in a color different from the color of the outer edge. Displaying the predicted course region in a color different from that of the outer edge makes it possible to display the predicted course region emphasized.

As a change from the displaying before the execution of the predetermined processing, for example, any change is possible as long as the driver can recognize that the displaying has been changed from before the execution of the predetermined processing, examples of which include a change of the color of the predicted course line, a change of the type of line, a change from a standard display to a flashing display.

For example, as illustrated in FIG. 5, when the steering angle of operator 10 reaches the maximum angle in the teaching travel, predetermined processing is performed to change the solid line displaying as in FIG. 4 to the broken line displaying.

Thus, the driver can recognize that the current operation amount of operator 10 is outside the operation range in which the automatic parking is executable. As a result, it is possible to suppress the occurrence of an error in the route following during the automatic parking by the driver performing an action such as adjusting the operation of operator 10 in the teaching travel.

Additionally, as predetermined processing may be, for example, processing for displaying guidance related to a driving operation, such as an instruction to decrease the steering angle, or for displaying a warning notification indicating, e.g., that the automatic parking cannot be performed because the steering angle is too large. Such processing may also be, for example, processing for displaying texts such as “Please decrease steering angle” or “Steering angle is too large” on display 30.

Further, determiner 110 may change the operation range in which the automatic parking is executable in accordance with the speed of vehicle 1.

For example, when the speed of vehicle 1 is relatively high during the teaching travel (for example, in a case where the speed is higher than a predetermined speed), the driver performs an operation of turning the steering wheel (steering) relatively quickly. For this reason, when this operation is reproduced by the automatic parking, there is a possibility that the operation control on operator 10 cannot keep up, which may cause an error in the route following.

In this case, for example, determiner 110 narrows the operation range in which the automatic parking is executable, and sets a determination threshold for the steering angle to an angle smaller than the predetermined angle described above.

Accordingly, since the predetermined processing is executed at a timing at which the steering angle does not become relatively large, it is possible to make the driver recognize relatively early that the operation amount is outside the operation range of the automatic parking. As a result, it is possible to suppress the occurrence of an error in the route following during the automatic parking, due to the speed of vehicle 1 in the teaching travel.

Further, in a case where the driver does not adjust the operation of operator 10 or in a case where the adjustment of the operation of operator 10 by the driver is insufficient (that is, in a case where the operation amount continues to exceed a predetermined range) after executor 120 has executed predetermined processing, executor 120 continues to execute the predetermined processing.

Accordingly, it is possible to urge the driver to adjust the operation of operator 10. Additionally, at this time, processing is also executed for urging the driver to adjust the operation (for example, processing for instructing the driver to decrease the steering angle, or the like).

Further, in a case where the teaching travel ends while the driver does not adjust the operation of operator 10 or in a case where the teaching travel ends while the adjustment of the operation of operator 10 by the driver is insufficient after executor 120 has executed predetermined processing, executor 120 may execute processing for notifying the driver that the teaching travel has failed.

The processing for notifying the driver that the teaching travel has failed may include, for example, processing for displaying the notification on display 30, or in a case of a configuration with speaker 40 as described later, processing for outputting the notification through voice.

Further, in such a situation, executor 120 may execute processing for notifying the driver that it is necessary to retry the teaching travel, or processing for notifying to confirm whether to retry the teaching travel.

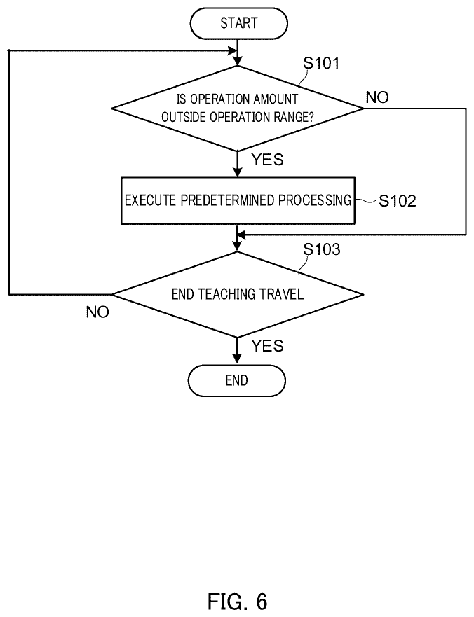

Next, an operation example of parking assistance apparatus 100 will be described. FIG. 6 is a flowchart illustrating an operation example of control during the teaching travel in parking assistance apparatus 100. The processing in FIG. 6 is executed, for example, when the teaching travel is started.

As illustrated in FIG. 6, parking assistance apparatus 100 determines whether an operation amount by a driver is outside an operation range (step S101). When it is determined that the operation amount is not outside the operation range (step S101, NO), the processing proceeds to step S103.

On the other hand, when the operation amount is outside the operation range (step S101, YES), parking assistance apparatus 100 executes predetermined processing (step S102). Next, parking assistance apparatus 100 determines whether teaching travel has ended (step S103).

A determination result indicates that the teaching travel has not ended (step S103, NO), the processing returns to step S101. On the other hand, when the teaching travel has ended (step $103, YES), the present control ends.

According to the present embodiment configured as described above, predetermined processing is executed in accordance with the determination result as to whether the operation amount by the driver during the teaching travel is outside the operation range in which automatic parking is executable; thus, the driver can recognize that the current operation amount of operator 10 is outside the operation range in which the automatic parking is executable. As a result, it is possible to suppress the occurrence of an error in the route following during the automatic parking by the driver performing an action such as adjusting the operation of operator 10 in the teaching travel.

Thus, it is possible to prevent the occurrence of a failure of automatic parking when the automatic parking is performed, and a retry of the teaching travel.

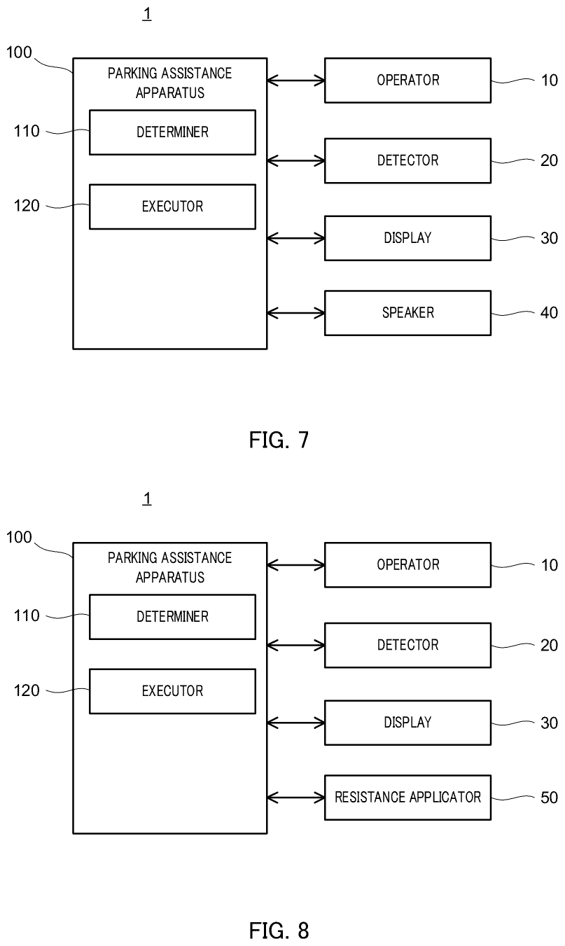

Note that, in the embodiment described above, the predetermined processing is processing related to display 30, but the present disclosure is not limited to this. For example, as illustrated in FIG. 7, in a case where vehicle 1 includes speaker 40, the predetermined processing may be processing for outputting sound via speaker 40 of vehicle 1.

Speaker 40 is, for example, a vehicle-mounted apparatus capable of outputting voice, such as a car navigation apparatus.

Examples of the processing for outputting the voice include processing for warning through voice that the current operation amount (steering angle) by the driver is too large, processing for notifying through voice the driver of guidance to decrease the steering angle, or the like.

The processing with voice allow the driver to recognize audibly that the current operation amount of operator 10 is outside the operation range in which the automatic parking is executable.

Further, for example, as illustrated in FIG. 8, when vehicle 1 includes resistance applicator 50, the predetermined processing may be processing for applying resistance to an operation performed by the driver.

For example, in a case where the steering angle of operator 10 (steering wheel) becomes equal to or greater than the predetermined angle described above, resistance applicator 50 applies a reaction force (resistance) to the steering. A publicly known technique can be used as resistance applicator 50.

The processing with resistance allows the driver can recognize tactilely that the current operation amount of operator 10 is outside the operation range in which the automatic parking is executable.

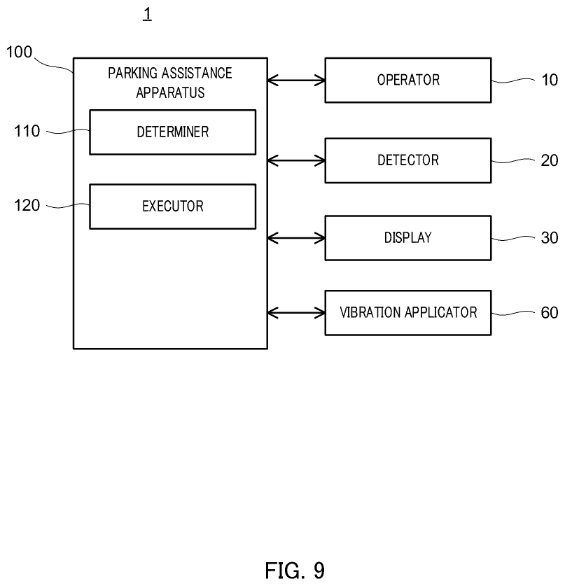

Further, for example, as illustrated in FIG. 9, when vehicle 1 includes vibration applicator 60, the predetermined processing may be processing for applying vibration to an operation amount of the driver.

For example, in a case where the steering angle of operator 10 (steering wheel) becomes equal to or greater than the predetermined angle described above, vibration applicator 60 applies vibration to the steering. A publicly known technique can be used as vibration applicator 60.

The processing with vibration allows the driver can recognize tactilely that the current operation amount of operator 10 is outside the operation range in which the automatic parking is executable.

In addition, in each of the embodiments described above, the predetermined processing was any of the processing involving display 30, speaker 40, resistance applicator 50, and vibration applicator 60, but the present disclosure is not limited to this, and processing is also possible in which two or more of display 30, speaker 40, resistance applicator 50, and vibration applicator 60 are combined.

Further, in the embodiments described above, the steering angle has been exemplified as the operation amount by the driver, but the present disclosure is not limited to this, and the operation amount may be, for example, a speed at which operator 10 (steering wheel) is turned. Specifically, for example, in a case where the speed at which operator 10 is turned is equal to or greater than a predetermined threshold (which can be set at random), determiner 110 determines that the operation amount by the driver exceeds the predetermined range.

When the speed at which operator 10 is turned is relatively high (equal to or greater than a predetermined threshold), the control of parking assistance apparatus 100 cannot keep up, which may cause an error in the route following during the automatic parking.

Accordingly, performing, as predetermined processing, processing for notifying the driver to turn operator 10 slowly through voice or displaying allows the driver to recognize that the current operation amount of operator 10 is outside the operation range in which the automatic parking is executable.

Further, the operation amount by the driver may be, for example, a speed of vehicle 1 based on operator 10 (accelerator pedal). Specifically, for example, in a case where the speed of vehicle 1 based on operator 10 is equal to or greater than a predetermined speed (which can be set at random), determiner 110 determines that the operation amount by the driver exceeds a predetermined range.

For example, when the speed of vehicle 1 during the teaching travel is relatively high (equal to or greater than a predetermined speed), a steering operation speed by the driver will be higher accordingly, and thus, in the automatic parking, there is a possibility that the operation control on the steering wheel is delayed and the route following is thereby delayed.

In this case, performing, as predetermined processing, processing for notifying the driver to decrease the speed of vehicle 1 through voice or displaying allows the driver to recognize that the current operation amount of operator 10 is outside the operation range in which the automatic parking is executable.

Further, during the teaching travel, the driver may turn the steering wheel in a state where vehicle 1 is stopped (in a state where the speed of vehicle 1 is 0). In this situation, when a steering wheel operation is controlled while vehicle 1 moves in the automatic parking, a relationship between the steering wheel operation and the speed of vehicle 1 may vary between the teaching travel and the automatic parking, which may consequently cause deviation in the route following.

In this case, performing, as predetermined processing, processing for notifying the driver to perform a steering operation by moving vehicle 1, through voice or displaying, allows the driver to recognize that the current operation amount of operator 10 is outside the operation range in which the automatic parking is executable.

The embodiments described above are merely examples of specific implementation of the present disclosure, and the technical scope of the present disclosure should not be restrictively interpreted by these embodiments. That is, the present disclosure may be implemented in various forms without departing from the spirit thereof or the major features thereof.

The disclosure of Japanese Patent Application No. 2022-087744, filed on May 30, 2022 including the specification, drawings and abstract, are incorporated herein by reference in its entirety.

### Industrial Applicability

The parking assistance apparatus of the present disclosure is useful as a parking assistance apparatus and a parking assistance method each capable of suppressing the occurrence of an error in route following during automatic parking.

1. A parking assistance apparatus performing parking assistance based on a route of a vehicle in teaching travel, the parking assistance apparatus comprising:
a processor that determines whether an operation amount of a driver in the teaching travel of the vehicle exceeds a predetermined range, wherein
the processor executes predetermined processing in a case where the operation amount exceeds the predetermined range.

2. The parking assistance apparatus according to claim 1, wherein the predetermined processing is processing for notifying the driver that the operation amount is outside the predetermined range.

3. The parking assistance apparatus according to claim 1, wherein:
the operation amount is a steering angle, and
the processor determines that the operation amount has exceeded the predetermined range in a case where the steering angle is equal to or greater than a predetermined angle.

4. The parking assistance apparatus according to claim 1, wherein the predetermined processing is processing for applying resistance to an operation performed by the driver.

5. The parking assistance apparatus according to claim 1, wherein the predetermined processing is processing for changing a predetermined display content on a display of the vehicle from a display content before execution of the predetermined processing.

6. The parking assistance apparatus according to claim 5, wherein the predetermined display content is a predicted course line of the vehicle.

7. The parking assistance apparatus according to claim 1, wherein the predetermined processing is processing for outputting sound from a speaker of the vehicle.

8. The parking assistance apparatus according to claim 1, wherein the processor changes an operation range of the driver for the vehicle in accordance with a speed in the teaching travel.

9. The parking assistance apparatus according to claim 8, wherein:
the operation amount is a steering angle, and
the processor sets a determination threshold for the steering angle to an angle smaller than a predetermined angle in a case where a speed of the vehicle in the teaching travel is higher than a predetermined speed.

10. The parking assistance apparatus according to claim 1, wherein, in a case where the operation amount continues to exceed the predetermined range after the predetermined processing is executed, the processor continues to execute the predetermined processing.

11. A parking assistance method for performing parking assistance based on a route of a vehicle in teaching travel, the parking assistance method comprising:
determining whether an operation amount of a driver in the teaching travel of the vehicle exceeds a predetermined range; and
executing predetermined processing in a case where the operation amount exceeds the predetermined range.
